(19) United States
(12) Patent Application Publication
(10) Pub. No.: US 2015/0347504 A1
(43) Pub. Date: Dec. 3, 2015

(54) ELECTRONIC APPARATUS, METHOD AND STORAGE MEDIUM

(71) Applicant: KABUSHIKI KAISHA TOSHIBA, Tokyo (JP)

(72) Inventor: Toshiya NAKANO, Tokyo (JP)

(73) Assignee: KABUSHIKI KAISHA TOSHIBA, Tokyo (JP)

(21) Appl. No.: 14/722,615

(22) Filed: May 27, 2015

(30) Foreign Application Priority Data
May 30, 2014 (JP) 2014-112520

(51) Int. Cl. G06F 17/30

(52) U.S. Cl. CPC G06F 17/30401; G06F 17/30268; G06F 17/30595

(57) ABSTRACT

According to one embodiment, an electronic apparatus includes a processing circuit. The processing circuit is configured to acquire screen image data representing a screen image of the electronic apparatus including a window displayed by execution of software, acquire log data including time and date when the screen image data is acquired and software data indicating the software, and store the screen image data associated with the log data in a storage.

### CROSS-REFERENCE TO RELATED APPLICATIONS

This application is based upon and claims the benefit of priority from Japanese Patent Application No. 2014-112520, filed May 30, 2014, the entire contents of which are incorporated herein by reference.

### FIELD

Embodiments described herein relate generally to an electronic apparatus, a method, and a storage medium.

### BACKGROUND

Recently, various electronic apparatuses such as notebook or desktop computers and tablet computers are being used in general business operations.

Since such an electronic apparatus enables the user, for example, to look up information necessary for work, access shared folders on a server, or the like, the user can perform business operations efficiently.

However, in a case where the user does not store information or the like which the user has been looked up, the user needs to perform an operation to look it up again, and thus the efficiency or business operations decreases. Further, for example, the same also applies to a case where the user forgets the path of a shared folder on the server which the user has been using.

Therefore, it is desirable to store data which enables the user to easily view (look up) the information or the like again later.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective diagram showing an example of an appearance of an electronic apparatus according to an embodiment.

FIG. 2 is a diagram showing an example of a system configuration of the electronic apparatus of FIG. 1.

FIG. 3 is a block diagram mainly showing an example of a function structure of the electronic apparatus according to the present embodiment.

FIG. 4 is a flowchart showing an example of a procedure of screen image data storage processing.

FIG. 5 is a diagram showing an example of a data structure of a screen image data storage.

FIG. 6 is a flowchart showing an example of a procedure of a screen image data display processing.

### DETAILED DESCRIPTION

Various embodiments will be described hereinafter with reference to the accompanying drawings.

In general, according to one embodiment, an electronic apparatus includes a processing circuit. The processing circuit is configured to acquire screen image data representing a screen image of the electronic apparatus including a window displayed by execution of software; acquire log data including time and date when the screen image data is acquired and software data indicating the software; and store the screen image data associated with the log date in a storage.

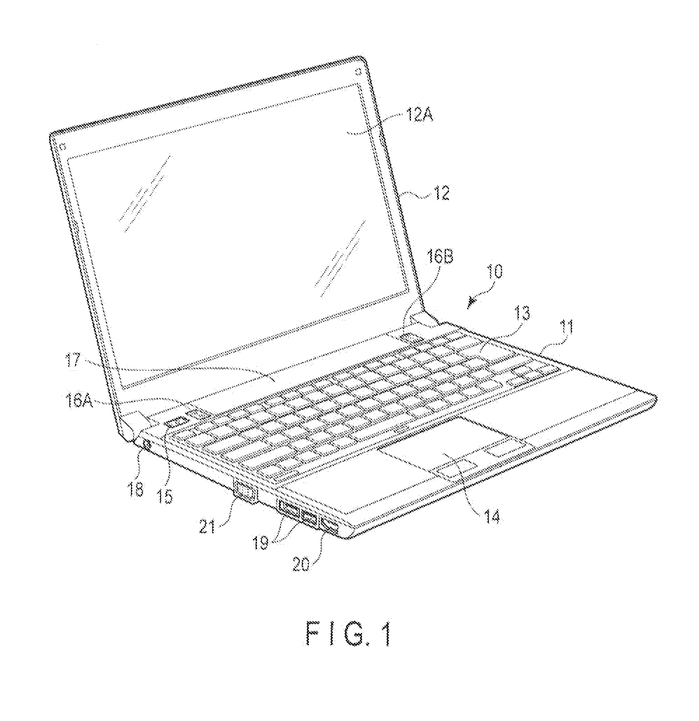

FIG. 1 is a perspective diagram showing an appearance of an electronic apparatus of an embodiment. This electronic apparatus may be realized as various electronic apparatuses operated by the user such as a notebook computer, a desktop computer or a tablet computer. In FIG. 1, this electronic apparatus is assumed to be realized as, for example, a notebook computer (PC).

As shown in FIG. 1, an electronic apparatus 10 includes an electronic apparatus body (computer body) 11 and a display unit 12. The display unit 12 includes a built-in display device such as a liquid crystal display (LCD) 12A.

The display unit 12 is attached to the electronic apparatus body 11 rotatably between an open position in which the upper surface of the electronic apparatus body 11 is exposed and a closed position in which the upper surface of the electronic apparatus body 11 is covered with the display unit 12. The electronic apparatus body 11 includes a thin box-shaped housing, and on the upper surface thereof, a keyboard 13, a touchpad 14, a power switch 15 configured to power the electronic apparatus 10 on and off, end speakers 16A and 16B are provided.

Further, the electronic apparatus 10 is configured to receive power from a battery 17. In the present embodiment, the battery 17 is built into the electronic apparatus 10, for example.

Still further, the electronic apparatus body 11 is provided with a power connector (DC power input terminal) 18. The power connector 18 is provided on a side surface, for example, on the left side surface of the electronic apparatus body 11. To the power connector 18, an external power device is detachably connected. As the external power device, an AC adaptor may be used. The AC adaptor is a power device configured to convert commercial power (AC power) to DC power.

The electronic apparatus 10 is configured to be driven by power supplied from the battery 17 or power supplied from an external power device. When an external power device is not connected to the power connector 18 of the electronic apparatus 10, the electronic apparatus 10 is driven by the power supplied from the battery 17. When an external power apparatus is connected to the power connector 18 of the electronic apparatus 10, on the other hand, the electronic apparatus 10 is driven by the power supplied from the external power device. Further, the power supplied from an external power device is also used for charging the battery 17.

Still further, the electronic apparatus body 11 is provided with several USB ports 19, a High-definition Multimedia Interface (registered trademark) (HDMI) output socket 20 and an RGB port 21.

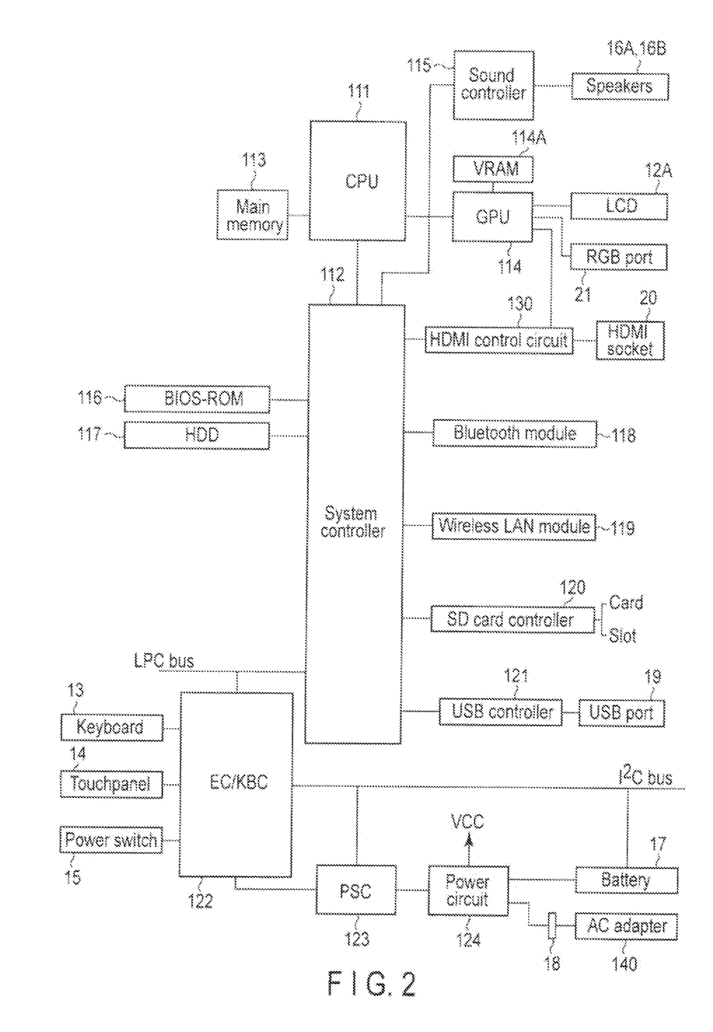

FIG. 2 is a diagram showing a system configuration of the electronic apparatus of FIG. 1. The electronic apparatus 10 includes a CPU 111, a system controller 112, a main memory 113, a graphics processing unit (GPU) 114, a sound controller 115, a BIOS-ROM 116, a hard disk drive (HDD) 117, a Bluetooth (registered trademark) module 118, a wireless LAN module 119, an SD card controller 120, a USB controller 121, an embedded controller/keyboard controller IC (EC/KBC) 122, a power-supply controller (PSC) 123 and a power circuit 124, etc.

The CPU 111 is a processor configured to control the operation of each component of the electronic apparatus 10. The processor includes a processing circuit. The CPU 111 executes software loaded from the HDD 117 to the main memory 113 such as an operating system (OS), various utility programs and various application programs.

Note that, in the present embodiment, the utility programs executed by the CPU 111 include a program (hereinafter referred to as a screen image data storage program) for automatically acquiring screen image data representing a screen image of the electronic apparatus 10.

Further, the CPU 111 also executes a basic input/output system (BIOS) stored in a nonvolatile memory, namely, the BIOS-ROM 116. The BIOS is a system program for hardware control.

The system controller 112 is a bridge device configured to connect the CPU 11 and each component with each other. The system controller 112 includes a built-in Serial ATA controller configured to control the HDD 117. Further, the system controller 112 executes communication with each device on a Low Pin Count (LPC) bus.

The GPU 114 is a display controller configured to control the LCD 12A used as a display monitor of the electronic apparatus 10. The GPU 114 generates a display signal (LVDS signal) to be supplied to the LCD 12A from display data stored in a video memory (VRAM) 114A.

Further, the GPU 114 can also generate an HDMI video signal and an analog RGB signal from the display data. The HDMI output socket 20 can transmit the HDMI video signal (uncompressed digital video signal) and a digital audio signal to an external display by a single cable. Further, the analog RGB signal is supplied to an external display via the RGB port 21.

Note that an HDMI control circuit 130 of FIG. 2 is an interface configured to transmit the HDMI video signal and the digital audio signal to an external display via the HDMI output socket 20.

The sound controller 115 is an audio device and configured to output audio data to be reproduced, for example, to the speakers 16A and 16B.

The Bluetooth module 118 is a module configured to execute wireless communication with a Bluetooth-compatible device by using Bluetooth.

The wireless LAN module 119 is a module configured to execute wireless communication conforming to, for example, the IEEE 802.11 standard.

The card controller 120 is configured to execute an operation to write data to or read data from a memory card inserted into a card slot provided in the electronic apparatus body 11.

The USB controller 121 is configured to execute communication with an external device connected via the USB port 19.

The EC/KBC 122 is connected to the LPC bus. Further, the EC/KBC 122 is interconnected with the PSC 124 and the battery 17 via a serial bus such as an I²C bus.

The EC/KBC 122 is a power management controller configured to perform power management of the electronic apparatus 10 and realized as, for example, a single-chip microcomputer including a built-in keyboard controller configured to control the keyboard (KB) 13, the touchpad 14 and the like. The EC/KBC 122 includes a function of powering the electronic apparatus 10 on and off based on the user's operation on the power switch 15. The control to power the electronic apparatus 10 on and off is executed by the EC/KBC 122 and the PSC 123 in cooperation. When receiving an ON signal transmitted from the EC/KBC 122, the PSC 123 controls the power circuit 124 to power the electronic apparatus 10 on. Further, when receiving an OFF signal transmitted from the EC/KBC 122, the PSC 123 controls the power circuit 124 to power the electronic apparatus 10 off.

The power circuit 124 generates power (operation power Vcc) to be supplied to each component by using power supplied from the battery 17 or power supplied from the AC adaptor 140 connected to the electronic apparatus body 11 as an external power apparatus.

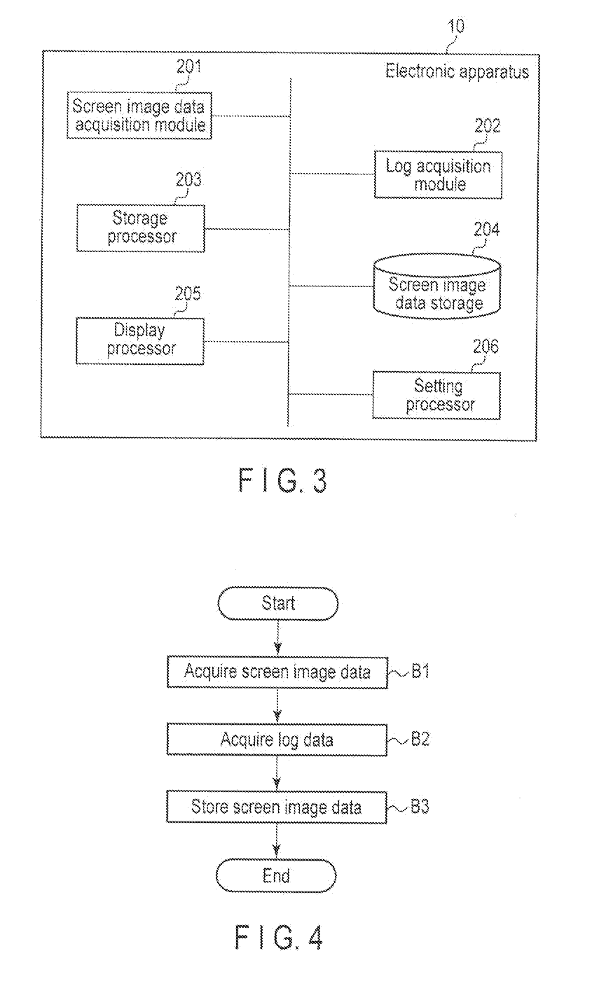

FIG. 3 is a block diagram mainly showing a function structure of the electronic apparatus 10 of the present embodiment. As shown in FIG. 3, the electronic apparatus 10 includes a screen image date acquisition module 201, a log acquisition module 202, a storage processor 203, a screen image data storage 204, a display processor 205 and a setting processor 206.

In the present embodiment, the screen image data acquisition module 201, the log acquisition module 202, the storage processor 203, the display processor 205 and the setting processor 206 are realized, for example, when the above-described screen image data storage program is executed by (the computer of the electronic apparatus 10, namely,) the CPU 111.

The screen image data acquisition module 201 is configured to acquire screen image data representing a screen image of the electronic apparatus 10 operated by the user, the screen image including a window displayed when various kinds of software are executed on the electronic apparatus 10. Note that the screen image data includes image data (screen-capture data) acquired by capturing a screen image of the electronic apparatus 10, and the screen image data is acquired, for example, at regular intervals while the electronic apparatus 10 is on.

The log acquisition module 202 is configured to acquire, when screen image data is acquired by the screen image data acquisition module 201, log data including time and date when the screen image data is acquired and a software data indicating software which is executed to display a window included in the screen image represented by the screen image data (that is, software which displays a window). The software data includes, for example, a utility (application) name or the like.

The storage processor 203 is configured to store (save) in the screen image data storage 204 screen image data acquired by the screen image data acquisition module 201 and log data (time and date, and software data) acquired by the log acquisition module 202.

The display processor 205 displays, for example, a list of items of screen image data organized by software (that is, a utility name) indicated by the software data included in the log data stored in the screen image data storage 204 baaed on the user's operation of the electronic apparatus 10. Note that the user can specify and view a desired item of screen image data from the list of items of screen image data displayed by the display processor 205.

The setting processor 206 is configured to set the interval and the period of the acquisition of the screen image data based on the user's operation of the electronic apparatus 10.

Now, the operation of the electronic apparatus 10 of the present embodiment will be described. Here, the processing to acquire and store the above-described screen image data (hereinafter referred to as screen image storage processing) and the processing to display the screen image data (hereinafter referred to as screen image display processing) in the electronic apparatus 10 will be mainly described. Note that this processing is realized by the execution of the above-described screen image data storage program.

First, with reference to the flowchart of FIG. 4, the procedure of the screen image data storage processing will be described.

The screen image data acquisition module 201 acquires screen image data representing a screen image of the electronic apparatus 10 (block B1). This screen image data includes bitmap image data acquired by capturing a screen image of the electronic apparatus 10 as described above. Further, the screen image represented by the screen image data acquired by the screen image data acquisition module 201 includes a window displayed by the execution of software on the electronic apparatus 10.

Further, the log acquisition module 202 acquires, when the screen image data is acquired by the above-described screen image data acquisition module 201, log data including the time and date when the screen image data is acquired and the name of a utility which displays a window in the screen image represented by the screen image data (that is, the software data indicating software executed to display the window) (block B2). Note that this log data is, for example, text data. Further, the name of a utility included in the log data is acquired, for example, via the operating system which operates on the electronic apparatus 10.

Note that, in a case where the screen image represented by the screen image data acquired by the screen image data acquisition module 201 includes a plurality of windows, the log acquisition module 202 is assumed to acquire, for example, at least the utility name of the software which displays an active window (parent window) in an active state.

Next, the storage processor 203 stores the screen image data acquired by the screen image data acquisition module 201 associated with the log data acquired by the log acquisition module 202 (block B3). That is, the storage processor 203 stores the screen image data and the log data in association.

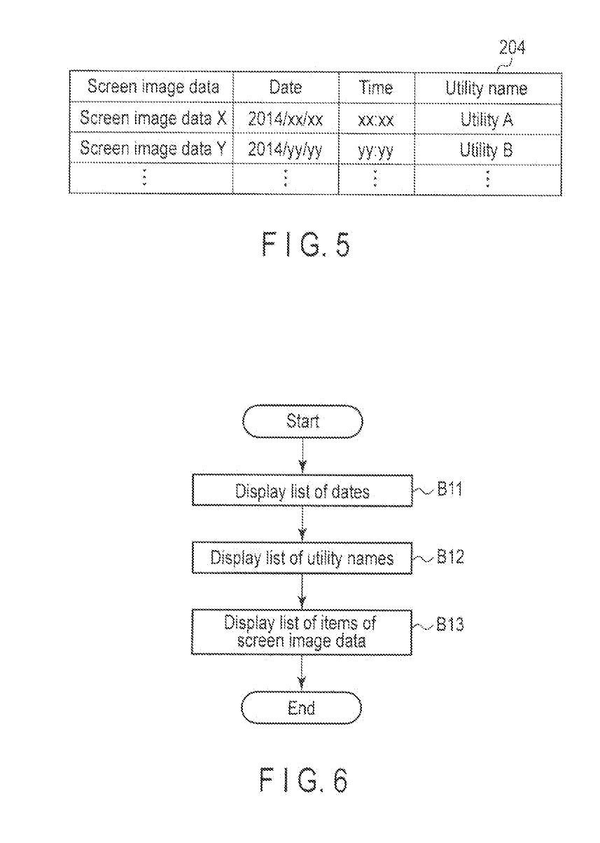

Here, with reference to FIG. 5, an example of the data structure of the screen image data storage 204 will be described. In the example shown in FIG. 5, the screen image data storage 204 stores, for example, the screen image data: “screen image data X”, and the log data including the date: “2014/xx/xx”, the time: “xx:xx” and the utility name: “utility A” in association. This shows that the time and date when the screen image data: “screen image data X” was acquired is xx (hour) xx (minute), xx (month) xx (day), 2014 (year), and the software which displays a window in the screen image represented by the screen image data: “a area a image dates X” is “utility A”.

Similarly, the screen image data storage 204 stores, for example, the screen image data: “screen image data Y”, and the log data including the date: “2014/yy/yy”, the time: “yy:yy” and the utility name: “utility A”. This shoes that the time and date when the screen image data: “screen image data Y” was acquired is yy (hour) yy (minute), yy (month) yy (day), 2014, and the software which displays a window in the screen image represented by the screen image data: “screen image data Y” is “utility A”.

Note that the screen image data acquired by the screen image data acquisition module 201 is stored, for example, as organized by the name of a utility included in the log data acquired by the log acquisition module 202.

As described above, according to the screen image data storage processing, it becomes possible to automatically acquire screen image data and store the screen image data in the screen image data storage 204 in association with log data including the time and date and the name of a utility.

Note that the screen image data storage processing is executed at acquisition intervals set by the above-described setting processor 206. That is, in the present embodiment, the screen image data is acquired regularly at the acquisition intervals set by the setting processor 206.

Further, this screen image data storage processing is realized by the execution of the above-described screen image data storage program, and the screen image data storage program is assumed to be activated automatically in the background when the electronic apparatus 10 is powered on. That is, the screen image data storage processing (processing of the screen image data acquisition module 201, the log acquisition module 202 and the storage processor 203 described above with reference to FIG. 4) is executed automatically when the electronic apparatus 10 is powered on. Note that the screen image storage program is, for example, assumed to operate continuously until the electronic apparatus 10 is powered off.

Further, in a case where an acquisition period is set by the setting processor 206 as described above, only screen image data acquired for the acquisition period is stored in the screen image data storage 204. More specifically, the storage processor 203 overwrites existing screen image data associated with (log data including) the time and date prior to the set acquisition period with screen image data newly acquired by the screen image data acquisition module 201. In this way, in a case where the acquisition period is set to, for example, one week, it is possible to store only the screen image data of the past week at all times since screen image data the date of which was more than a week ago is overwritten in chronological order.

Further, although it has been assumed that the above-described utility name is acquired via the operating system in FIG. 4, the log acquisition module 202 may acquire the name of a utility by analyzing screen image data acquired by the screen image data acquisition module 201. More specifically, it is possible to analyze (extract) a character string or the like in (a window included in) the screen image represented by the screen image data by optical character recognition (OCR) processing and acquire the name of a utility based on the character string. In that case, the character string (text) extracted by the optical character recognition processing may also be used in other processing or the like.

Further, it has been assumed that the time and date and the name of a utility are acquired as log data, but in addition to the time and date and the name of a utility, the log data may also include the name of a file opened in the above-described execution of software.

Next, with reference to the flowchart of FIG. 6, the procedure of the screen image data display processing will be described. First, in a case where the user is to view screen image data acquired in the above-described screen image data storage processing (that is, stored in the screen image data storage 204), the display processor 205 displays a list of (folders of) dates of the acquisition of the screen image data in the past (block B11). In this case, the display processor 205 displays a list of dates included in respective items of log data stored in the screen image data processor 204 such as, for example, that of FIG. 5 described above.

Here, the user can select a desired date from the displayed list of dates by performing an operation on the electronic apparatus 10.

When a date is selected by the user in this way, the display processor 205 displays a list of (folders of) utility names associated with the selected date in the screen image data storage 204 (block B12).

When a list of utilities is displayed in this way, the user can further select a desired utility name from the lists of utility names.

When a utility name is selected by the user, the display processor 205 displays a list of items of screen image data associated with the selected utility name in the screen image data storage 204 (step S13). In this case, these items of screen image data are displayed in chronological order based on times associated with the respective items of screen image data in the screen image data storage 204. Note that, in the list of these items of screen image data, the screen image data is displayed, for example, in thumbnail format. Further, when one of those items of screen image date in the list is selected by the user, the selected screen image data is then displayed.

As described above, according to the screen image data display processing, it is possible to display the screen image data stored in the screen image data storage 204 as organized by the folder of a utility name corresponding to the date selected by the user.

Note that, although it has been assumed that the list of items of screen image data is displayed when a utility name is selected by the user, the log data stored in the screen image data storage 204 may include the name of a file as described above. In this case, when a desired utility name is selected by the user, a list of (folders of) file names associated with the selected utility name in the screen image data storage 204 may be further displayed. After the list of file names is displayed, the user can select a desired file name from the list. When a file name is selected by the user in this way, a list of items of screen image data associated with the selected file name is displayed. In this way, it is possible to display a plurality of items of screen image data organized by the folder of a file name corresponding to a selected utility name.

Further, although it has been assumed that a list of items of screen image data is displayed when a date and then a utility name are selected by the user, when the log data stored in the screen image data storage 204 includes the name of a file as described above and when a file name is specified directly, items of screen image data corresponding to the selected file name may be display in chronological order.

As described above, in the present embodiment, screen image data representing a screen image of the electronic apparatus 10 including a window displayed by execution of software is acquired regularly, and log data including time and date when the screen image data is acquired and software data indicating the software (for example, the name of a utility) is acquired, and the acquired screen image data and log data are stored in the screen image data storage 204 in association. In the present embodiment, it becomes possible with this configuration to store data of a screen image of the electronic apparatus 10 automatically without the user intentionally performing a specific operation.

Further, in the present embodiment, it becomes possible, by displaying the screen image data organized by software (for example, the name of a utility) indicated by the software data in the log data stored in the screen image data storage 204 in association with the screen image data, to improve visibility to the screen image data when a user selects the screen image data of the past. That is, in the present embodiment, since the user can easily refer to screen image data of the past, it is possible, for example, to reduce the number of back tracking processes to look up data acquired in the electronic apparatus 10 in the past. Therefore, it is possible to improve the efficiency of business operations.

Still further, in the present embodiment, Screen image data is acquired regularly at set intervals. Thus, it is possible to realize automatic acquisition of screen image data intended by user. Still further, in the present embodiment, screen image data stored in the screen image data storage 204 in association with the log data including time and date prior to a set period is overwritten with newly acquired screen image data, and thus it is possible to prevent an increase in the amount of data stored in the screen image data storage 204.

Still further, in the present embodiment, the processing for acquiring the screen image data, processing for acquiring the log data and processing for storing the screen image data (that is, processing of the screen image data acquisition module 201, the log acquisition module 202 and the storage processor 203) are automatically executed when the electronic apparatus 10 is powered on (that is, the above-described screen image data storage program operates continuously while the electronic apparatus 10 is on), and therefore it is possible to acquire necessary screen image data without fail.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a processing circuit configure to:
acquire screen image data representing a screen image of the electronic apparatus including a window displayed by execution of software;
acquire log data including time and date when the screen image data is acquired and software data indicating the software; and
store the screen image data associated with the log data in a storage.

2. The electronic apparatus of claim 1, wherein the processing circuit is configured to display the screen image data organized by the software indicated by the software data included in the log data stored in the storage.

3. The electronic apparatus of claim 1, wherein the processing circuit is configured to set an interval for the acquisition of the screen image data, and
acquire the screen image data regularly at the set intervals.

4. The electronic apparatus of claim 1, wherein the processing circuit is configured to set a period for the acquisition of the screen image data, and
overwrites the screen image data stored in the storage in association with the log data including time and date prior to the set period with the acquired screen image data.

5. The electronic apparatus of claim 1, wherein processing for acquiring the screen image data, processing for acquiring the log data and processing for storing the screen image data are executed automatically when the electronic apparatus is powered on.

6. The electronic apparatus of claim 1, wherein the processing circuit is configured to acquire the software data via an operating system which operates on the electronic apparatus.

7. The electronic apparatus of claim 1, wherein the processing circuit is configured to acquire the software data by analyzing the screen image data.

8. A method executed by en electronic apparatus comprising a storage, the method comprising:
acquiring screen image data representing a screen image of the electronic apparatus including a window displayed by execution of software;
acquiring log data including time and date when the screen image data is acquired and software data indicating the software; and
storing the screen image data associated with the log data in the storage.

9. A non-transitory computer-readable storage medium having stored thereon a computer program which is executable by a computer of an electronic device comprising a storage, the computer program comprising instructions capable of causing the computer to execute functions of:
acquiring screen image data representing a screen image of the electronic apparatus including a window displayed by execution of software;
acquiring log data including time and date when the screen image data is acquired and software data indicating the software; and
storing the screen image data associated with the log data in the storage.
